(19) United States
(12) Patent Application Publication
(10) Pub. No.: US 2014/0168886 A1
(43) Pub. Date: Jun. 19, 2014

(54) MOTHERBOARD MODULE HAVING AIR DUCT WITH INDICATORS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BO TIAN, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/730,694

(22) Filed: Dec. 28, 2012

(30) Foreign Application Priority Data
Dec. 18, 2012 (CN) 201210550761.5

(51) Int. Cl. G06F 1/20

(52) U.S. Cl. CPC G06F 1/20
USPC 361/679.46; 138/104

(57) ABSTRACT

An air duct includes a main body mounted on a motherboard and an indicating apparatus installed to the main body. The motherboard includes a first connector for outputting signals of the working states of the motherboard. The main body defines a number of through holes. The indicating apparatus includes a number of indicators respectively received in and exposed through the through holes, a second connector installed to the main body and electrically connected to the first connector, and a number of cables respectively connected between the second connector and the indicators.

### BACKGROUND

1. Technical Field

The present disclosure relates to a motherboard module including an air duct with indicators.

2. Description of Related Art

Air ducts are installed on a motherboard for conducting airflows. The air ducts are generally made of opaque material. As a result, some indicators mounted on the motherboard may be obstructed. However, making air ducts with transparent material is costly. Thus air ducts with indicators are desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a motherboard module, together with an enclosure, wherein the motherboard module includes an air duct.

FIG. 2 is an inverted view of the air duct of FIG. 1.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

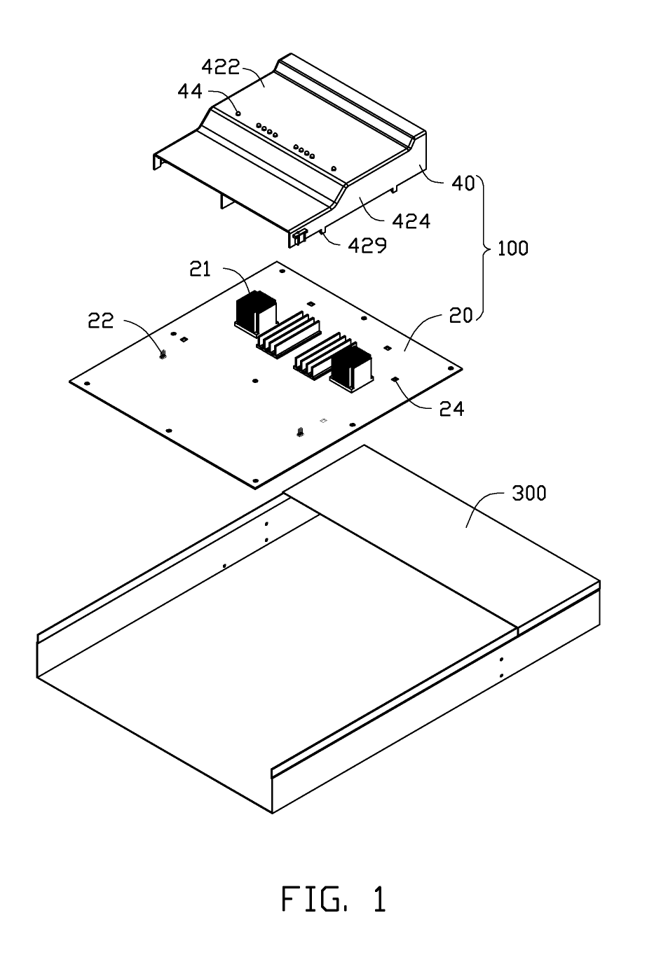

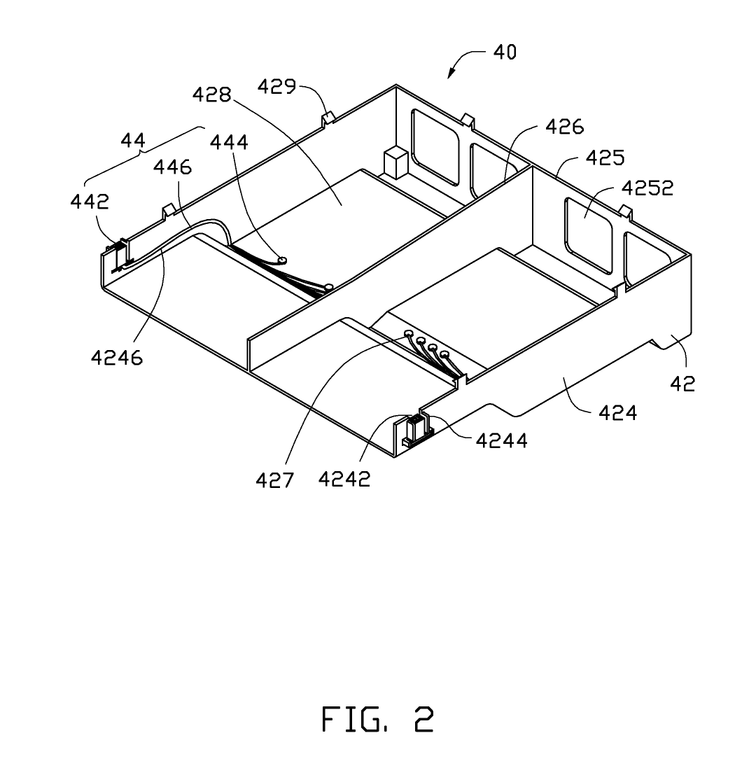

FIG. 1 and FIG. 2 show an exemplary embodiment of a motherboard module 100 including a motherboard 20 and an air duct 40.

The motherboard 20 can be installed in an enclosure 300. The motherboard 20 includes a plurality of heat sinks 21 mounted on a plurality of electronic components, such as central processing units, and two first connectors 22. The motherboard 20 defines a plurality of latching holes 24 around the heat sinks 21. Each first connector 22 is electrically coupled to the motherboard 20, to output operation state signals of the motherboard 20.

The air duct 40 includes a main body 42 and two indicating apparatus 44 installed on the main body 42.

The main body 42 includes a substantially rectangular top plate 422, two side plates 424 perpendicularly extending down from two opposite sides of the top plate 422, an end plate 425 perpendicularly extending down from an end of the top plate 422 and connected between the side plates 424, and a partition plate 426 extending down from the top plate 422 between and parallel to the side plates 424. The top plate 422, the side plates 424, and the partition plate 426 cooperatively bound two airflow channels 428. The end plate 425 defines a plurality of vents 4252. A middle of the top plate 422 defines a plurality of through holes 427. A bottom of each side plate 424 defines a cutout 4242 away from the end plate 425. A substantially U-shaped positioning portion 4244 perpendicularly extends out from edges bounding each cutout 4242. Inner surfaces of the top plate 422 and each side plate 424 respectively define a plurality of receiving slots 4246, two ends of each receiving slot 4246 respectively communicating with the corresponding cutout 4242 and the corresponding through hole 427. A plurality of hooks 429 extends down from the end plate 425 and each side plate 424.

Each indicating apparatus 44 includes a second connector 442 positioned in the corresponding positioning portion 4244, a plurality of indicators 444 respectively installed in the through holes 427, and a plurality of cables 446 each connected between the corresponding second connector 442 and the corresponding indicator 444. The cables 446 are respectively received in the receiving slots 4246. The indicators 444 can be light emitting diode indicators.

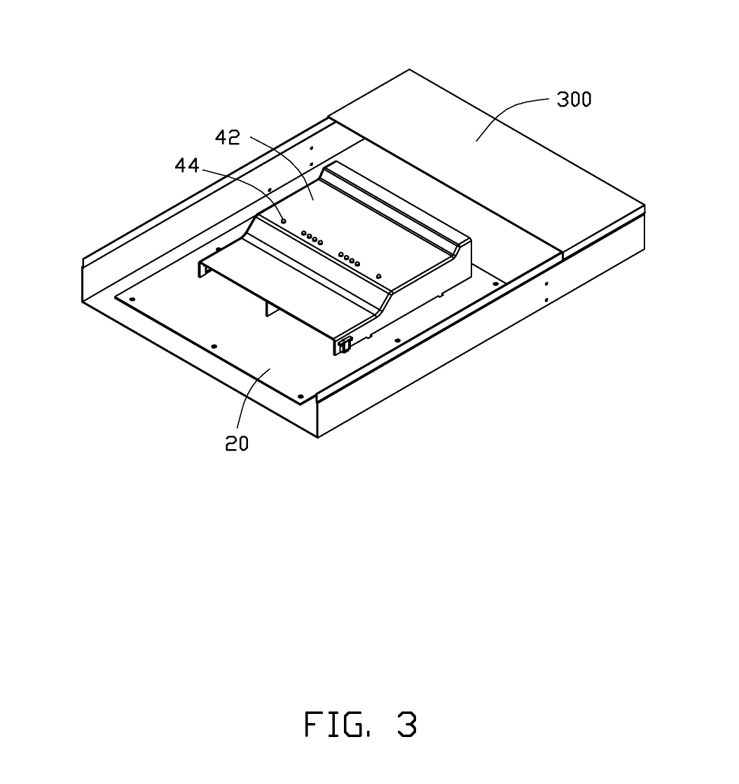

FIG. 3 shows the assembly of the motherboard module 100. The second connectors 442 of the air duct 40 are respectively inserted into the first connectors 22, and the hooks 429 are respectively inserted into the latching holes 24 of the motherboard 20. The heat sinks 21 are respectively received in the airflow channels 428. The indicating apparatus 44 are electrically connected to the corresponding first connectors 22 for indicating the operation states of the motherboard 20.

Because the indicators 444 are exposed through the main body 42 to be visible to users, inactive state or faulty state of the motherboard 20 can be directly shown through the indicators 444.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. An air duct, comprising:
a main body mounted on a motherboard, the main body defining a plurality of through holes; and
an indicating apparatus installed to the main body, the indicating apparatus comprising a plurality of indicators respectively received in and exposed through the plurality of through holes, a connector installed to the main body and electrically connected to the motherboard, and a plurality of cables respectively connected between the connector and the plurality of indicators.

2. The air duct of claim 1, wherein the main body comprises a top plate and a side plate extending down from a side of the top plate, the plurality of through holes is defined in the top plate.

3. The air duct of claim 2, wherein a positioning portion extends out from a lower portion of the side plate for positioning the connector.

4. The air duct of claim 3, wherein a bottom of the side plate defines a cutout, the positioning portion is U-shaped and extends from edges bounding the cutout.

5. The air duct of claim 4, wherein inner surfaces of the top plate and the side plate respectively define a plurality of receiving slots, two ends of each receiving slots respectively communicating with the cutout and the corresponding through hole, the cables are respectively received in the receiving slots.

6. A motherboard module, comprising:
a motherboard comprising a first connector to output signals of operation states of the motherboard; and
an air duct comprising a main body mounted on the motherboard and an indicating apparatus;
wherein the main body defines a plurality of through holes, the indicating apparatus comprises a plurality of indicators respectively received in and exposed through the plurality of through holes, a second connector is installed to the main body and electrically connected to the first connector of the motherboard, and a plurality of cables respectively connected between the second connector and the plurality of indicators.

7. The motherboard module of claim 6, wherein the main body comprises a top plate and a side plate extending down from a side of the top plate, the plurality of through holes is defined in the top plate.

8. The motherboard module of claim 7, wherein a positioning portion extends out from a lower portion of the side plate for positioning the second connector.

9. The motherboard module of claim 8, wherein a bottom of the side plate defines a cutout, the positioning portion is substantially U-shaped and extends from edges bounding the cutout.

10. The motherboard module of claim 7, wherein inner surfaces of the top plate and the side plate respectively define a plurality of receiving slots, two ends of each receiving slots respectively communicating with the cutout and the corresponding through hole, the plurality of cables are respectively received in the plurality of receiving slots.
